(19) United States
(12) Patent Application Publication
(10) Pub. No.: US 2026/0291896 A1
(43) Pub. Date: Sep. 24, 2026

(54) ENHANCEMENT OF COLLABORATION IN AD HOCLY CREATED COMMUNICATIONS GROUPS

(71) Applicant: MOTOROLA SOLUTIONS, INC., CHICAGO, IL (US)

(72) Inventors: TEJEASH DURAIMANICKAM, LUNAS (MY); ANOOP SEHGAL PARAS RAM, IPOH (MY); WOOI PING TEOH, TANJUNG TOKONG (MY); CHUN WEN OOI, GEORGETOWN (MY)

(21) Appl. No.: 19/695,152

(22) Filed: Jun. 2, 2026

Related U.S. Application Data
(63) Continuation-in-part of application No. 18/970,985, filed on Dec. 6, 2024.

(51) Int. Cl. H04L 51/02; G06Q 50/26

(52) U.S. Cl. CPC H04L 51/02; G06Q 50/265

(57) ABSTRACT

A method and system for a public safety investigation relating to a plurality of vehicles is disclosed. The method is carried out at least in part at a first location where at least one of a first vehicle and a second vehicle is parked, stationed or stopped. Based on a learning machine identifying one or more relationship link thresholds for the first and second vehicles having being met, a plurality of police officers, identified from both first and second police reports, are automatically assigned into a communications group (which is ad hocly created). The method also includes providing a notification to each of the assigned police officers that provides at least one implicit or explicit explanation for the automatic assigning to the communications group.

### CROSS-REFERENCE TO RELATED APPLICATIONS

This application is a continuation-in part of U.S. patent application Ser. No. 18/970,985, filed on Dec. 6, 2024, entitled “METHOD AND SYSTEM FOR PUBLIC SAFETY INVESTIGATION RELATING TO A PLURALITY OF VEHICLES”, the contents and teachings of which are hereby incorporated by reference in its entirety.

### BACKGROUND

A traffic stop, sometimes informally referred to as being pulled over, is a temporary detention of a driver of a vehicle (and potentially any additional vehicle occupants) by a police officer to investigate a possible crime or some other violation of law(s). Depending upon certain factors (e.g. the severity of the legal offense which the police officer believes to have occurred), the police officer may either arrest the suspect, by taking the suspect to jail, or check for any outstanding warrants before issuing a citation. By contrast, sometimes, such as in a case when a police officer arrives at a conclusion that there is insufficient evidence of a driver of a suspicious vehicle having broken a law, the driver and the suspicious vehicle may be permitted to depart from the location of the traffic stop with a police report of the traffic stop being created and electronically stored so as to ideally provide a detailed record of what occurred.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a block diagram of a collective system in accordance with example embodiments.

FIG. 2 is a flow chart illustrating a computer-implemented method in accordance with an example embodiment.

FIG. 3 is a diagram of example locations relevant to further illustrating operation of the collective system in accordance with an example embodiment.

FIG. 4 is a diagram of a first example user interface page illustrating video clips available to be viewed.

FIG. 5 is a diagram of a second example user interface page illustrating chatbot dialogs.

FIG. 6 is a diagram of third and fourth example user interface pages illustrating additional chatbot dialogs interspaced with police officer dialogs.

FIG. 7 is a diagram of a fifth example user interface page illustrating further additional chatbot dialogs interspaced with additional police officer dialog.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

In accordance with one example embodiment, there is provided a computer-implemented method carried out at least in part at a first location where at least one of a first vehicle and a second vehicle is parked, stationed or stopped. The computer-implemented method includes carrying out a computer-implemented records lookup to directly or indirectly identify the first and second vehicles and also, in respect of the at least one of the first vehicle and the second vehicle, one or more occupants of those vehicle(s) are under consideration for potential arrest or detention in connection with a legal offence. The computer-implemented method also includes retrieving, from at least one storage, at least one prior-created, first police report in relation to the first vehicle at a second location. The computer-implemented method also includes retrieving, from the at least one storage, at least one prior-created, second police report in relation to the second vehicle at a third location different than the second location. The computer-implemented method also includes inputting report data from each of the first and second police reports into a learning machine. Based on the learning machine identifying one or more relationship link thresholds for the first and second vehicles having being met, a plurality of police officers identified from both the first and second police reports are automatically assigning into a communications group, ad hocly created in respect of the legal offence. Also based on the learning machine identifying one or more relationship link thresholds for the first and second vehicles having being met, a notification is provided to each of the assigned police officers that provides at least one implicit or explicit explanation for the automatic assigning to the communications group.

In accordance with another example embodiment, there is provided a system that includes at least one processor and at least one electronic storage medium in communication with the at least one processor. The at least one electronic storage medium stores program instructions that when executed by the at least one processor cause the at least one processor to perform carrying out a computer-implemented records lookup to directly or indirectly identify first and second vehicles. In respect of the at least one of first vehicle and the second vehicle, parked, stationed or stopped at a first location, one or more occupants of those vehicle(s) are under consideration for potential arrest or detention in connection with a legal offence. The program instructions when executed by the at least one processor also cause retrieving, from at least one storage, at least one prior-created, first police report in relation to the first vehicle at a second location. The program instructions when executed by the at least one processor also cause retrieving, from the at least one storage, at least one prior-created, second police report in relation to the second vehicle at a third location different than the second location. The program instructions when executed by the at least one processor also cause inputting report data from each of the first and second police reports into a learning machine. Based on the learning machine identifying one or more relationship link thresholds for the first and second vehicles having being met, a plurality of police officers identified from both the first and second police reports are automatically assigning into a communications group, ad hocly created in respect of the legal offence. Also based on the learning machine identifying one or more relationship link thresholds for the first and second vehicles having being met, a notification is provided to each of the assigned police officers that provides at least one implicit or explicit explanation for the automatic assigning to the communications group.

In accordance with another example embodiment, there is provided a tangible, non-transitory, computer-readable storage medium having instructions encoded therein. The instructions, when executed by at least one processor, cause a carrying out of a method that includes providing a user interface for a communications group configured to permit communication of a plurality of electronic messages between a chatbot and a plurality of police officers. The electronic messages include at least one chatbot message. The execution of the program instructions by the at least one processor further causes carrying out a computer-implemented records lookup to directly or indirectly identify first and second vehicles (one or more occupants of the at least one of the first vehicle and the second vehicle are under consideration for potential arrest or detention in connection with a legal offence). The execution of the program instructions by the at least one processor further causes retrieving, from at least one storage, at least one prior-created, first police report in relation to the first vehicle. The execution of the program instructions by the at least one processor further causes retrieving, from the at least one storage, at least one prior-created, second police report in relation to the second vehicle. The execution of the program instructions by the at least one processor further causes inputting report data from each of the first and second police reports into a learning machine. The execution of the program instructions by the at least one processor further causes receiving output from the learning machine to generate the at least one chatbot message. The output describes one or more investigative lead suggestions relevant to investigation in respect of the legal offence.

Each of the above-mentioned embodiments will be discussed in more detail below, starting with example system and device architectures of the system in which the embodiments may be practiced, followed by an illustration of processing blocks for achieving an improved technical method, device, and system for a public safety investigation relating to a plurality of vehicles, and also enhancing collaboration in ad hocly created communications groups.

Example embodiments are herein described with reference to flowchart illustrations and/or block diagrams of methods, apparatus (systems) and computer program products according to example embodiments. It will be understood that at least some blocks of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (Saas), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

The term “vehicle” as used herein is understood to include any of a car, a truck, a van, a Sport Utility Vehicle (SUV), a bus, a motorcycle, a scooter, and the like. Also, depending on the context, a vehicle need not necessarily be a road vehicle, but instead might be some other type of vehicle such as, for instance, a boat.

Further advantages and features consistent with this disclosure will be set forth in the following detailed description, with reference to the figures.

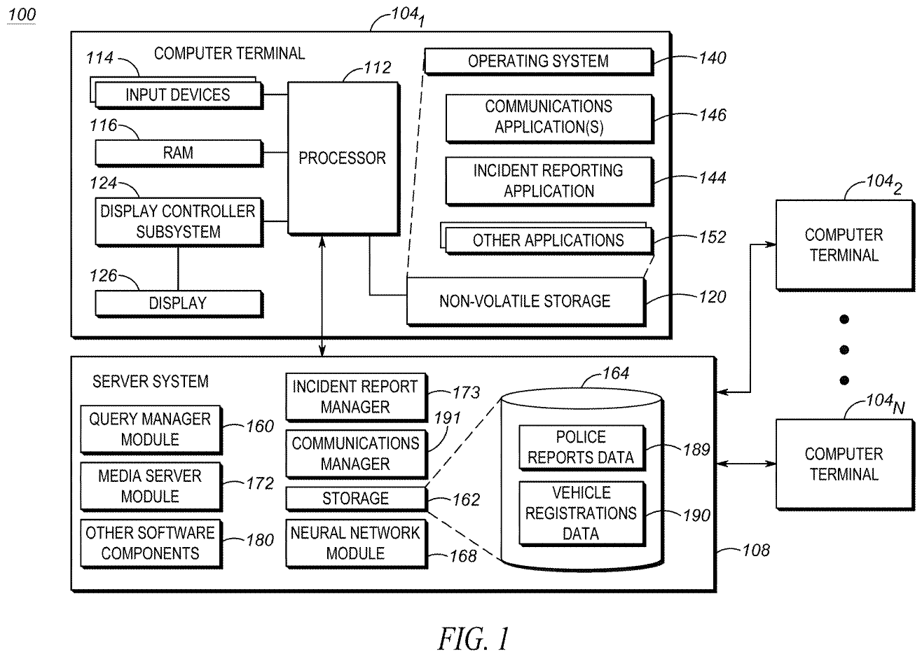

Referring now to the drawings, and in particular FIG. 1, which is a block diagram of an example collective system 100 within which methods in accordance with example embodiments can be carried out. Included within the illustrated collective system 100 are a server system 108 and one or more computer terminals 1041-104N (hereinafter interchangeably referred to as “computer (or computing) terminals 1041-104N” when referring to all of the illustrated computer terminals, or “computer (computing) terminal 104” when referring to any individual one of the plurality). In some example embodiments, the computer terminal 104 is a personal computer system; however in other example embodiments the computer terminal 104 is a selected one or more of the following: a handheld device such as, for example, a tablet, a phablet, a smart phone or a personal digital assistant (PDA); a laptop computer; a smart television; and other suitable devices. With respect to the server system 108, this could comprise a single physical machine or multiple physical machines. It will be understood that the server system 108 need not be contained within a single chassis, nor necessarily will there be a single location for the server system 108.

In the illustrated example embodiment, the computer terminal 104 may communicate with the server system 108 through one or more networks. In some examples, these networks may include some combination of communicatively connected wireless and wired networks, and can include the Internet, or one or more other public/private networks coupled together by network switches or other communication elements. The network(s) could be of the form of, for example, client-server networks, peer-to-peer networks, etc. Data connections between the computer terminal 104 and the server system 108 can be any number of known arrangements for accessing a data communications network, such as, for example, dial-up Serial Line Interface Protocol/Point-to-Point Protocol (SLIP/PPP), Integrated Services Digital Network (ISDN), dedicated lease line service, broadband (e.g. cable) access, Digital Subscriber Line (DSL), Asynchronous Transfer Mode (ATM), Frame Relay, or other known access techniques (for example, radio frequency (RF) links).

The computer terminal 104 includes at least one processor 112 that controls the overall operation of the computer terminal. The processor 112 interacts with various subsystems such as, for example, input devices 114 (such as a selected one or more of a keyboard, mouse, scanner, touch pad, roller ball and voice control means, for example), random access memory (RAM) 116, non-volatile storage 120, display controller subsystem 124 and other subsystems. The display controller subsystem 124 interacts with display screen 126 and it renders graphics and/or text upon the display screen 126.

Still with reference to the computer terminal 104 of the collective system 100, operating system 140 and various software applications used by the processor 112 are stored in the non-volatile storage 120. The non-volatile storage 120 is, for example, one or more hard disks, solid state drives, or some other suitable form of computer readable medium that retains recorded information after the computer terminal 104 is turned off. Regarding the operating system 140, this includes software that manages computer hardware and software resources of the computer terminal 104 and provides common services for computer programs. Also, those skilled in the art will appreciate that the operating system 140 (that includes computer program instructions), incident reporting application 144 (that also includes computer program instructions), communications application(s) 146 (that also includes computer program instructions), and other applications 152 (each of which also includes computer program instructions), or parts thereof, may be temporarily loaded into a volatile store such as the RAM 116. The processor 112, in addition to its operating system functions, can enable execution of the various software applications on the computer terminal 104.

With reference still to FIG. 1, the server system 108 of the collective system 100 includes a query manager module 160. The query manager module 160 enables various functions in relation to interfacing with the database 164 such as, for example, select query functionality (retrieving information from the database 164) and action query functionality (performing tasks with data for the database 164 such as, for instance, adding data, updating data, etcetera).

The server system 108 also includes at least one neural network module 168 (this provides artificial intelligence implemented by, for example, one or more convolutional neural networks and/or one or more other learning machines) associated with types of processing within the server system 108 that one skilled in the art would understand as employing artificial intelligence. For example, an at least one learning machine may be trained to identify commonality or complementary relationship links between respective details of the police reports. The commonality or complementary relationship links may relate to, for instance, at least one of an organization, at least one person, a dangerous substance produceable from two or more combinable chemicals, and a dangerous device produceable from two or more integrable components. In accordance with some examples, artificial intelligence as herein disclosed may be configured to computationally devise actions based at least in part on identifying one or more of the following: common drivers and/or vehicle owners; a common residence or origin of different drivers and/or vehicle owners; relationship (e.g. family, co-worker, etcetera) links between different drivers and/or vehicle owners; commonality or overlap in pattern(s) in relation to details regarding vehicles as it relates to previous travel; commonality as it relates to ownership, previously discovered evidence, etcetera; and potential links to common criminal or illegal activity.

The server system 108 also includes a media server module 172 to control streaming of audio and video data (in any suitable manner as will be readily understood by those skilled in the art).

The server system 108 also includes an incident report manager 173. In at least one example, the incident report manager 173 provides a server-side management function as it relates to each incident reporting application 144 on the computer terminals 1041-104N. For instance, the incident report manager 173 provides an interface to server-side data operations that may be carried out by the query manager module 160 and the database 164.

The server system 108 also includes a communications manager 191. In at least one example, the communications manager 191 provides a server-side management function as it relates to each of at least one communications application 146 on the computer terminals 1041-104N.

Regarding the database 164 mentioned above, it is provided in at least one storage 162. In the illustrated example embodiment, the database 164 stores police reports data 189 and vehicle registrations 190. The police reports data 189 and the vehicle registrations 190 are discussed in more detail later herein.

Still with reference to FIG. 1, the server system 108 also includes other software components 180. These other software components will vary depending on the requirements of the server system 108 within the overall system. As just one example, the other software components 180 might include special test and debugging software, or software to facilitate version updating of modules within the server system 108.

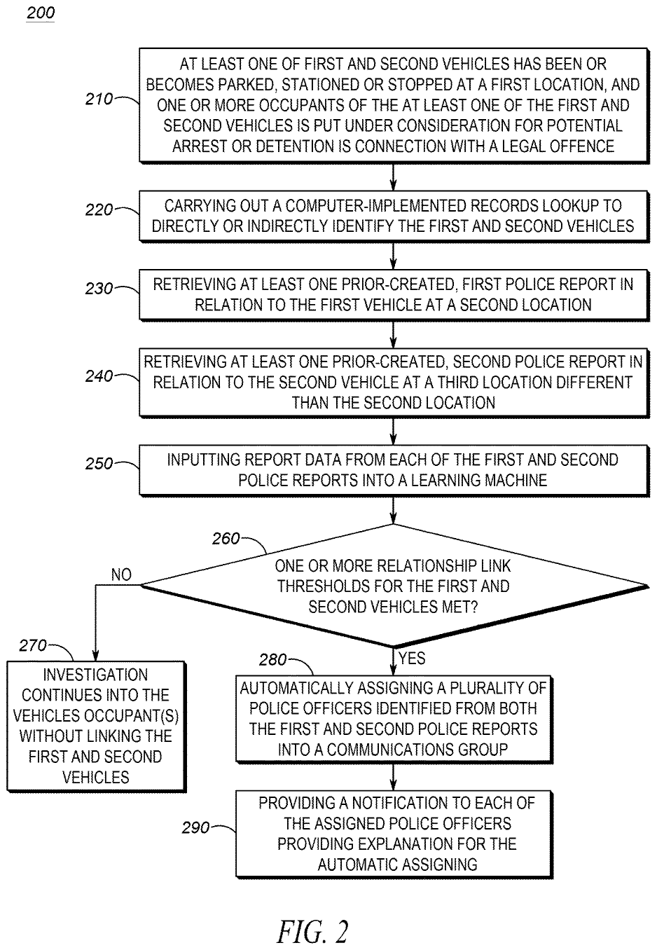

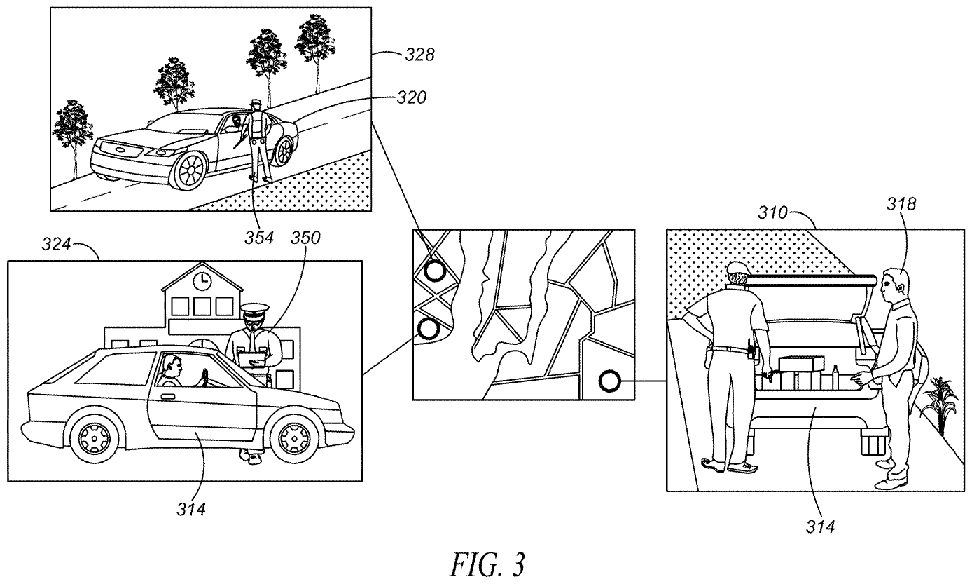

Reference is now made to both FIGS. 2 and 3. FIG. 2 is a flow chart illustrating a computer-implemented method 200 in accordance with an example embodiment. FIG. 3 is a diagram of example locations relevant in providing a further illustration of operation of the collective system 100 in accordance with an example embodiment.

The method 200 is carried out at least in part at a first location 310 where at least one of a first vehicle and a second vehicle (for example, vehicle 314 in FIG. 3) is parked, stationed or stopped. Thus, the first location may correspond to, for instance, a parking lot or a roadblock (although other types of locations compatible with the parking, stationing or stopping of a vehicle are also contemplated). Also, in the illustrated example, the vehicle 314 and vehicle 320 are road vehicles; however other type of vehicles beside road vehicles are also contemplated. In at least one example, computer-outputted response actions of the method 200 may be carried out in at least near real time.

Action 210 occurs firstly in the method 200, where one or more occupants (for example, person 318 in FIG. 3) of the at least one of a first vehicle and a second vehicle (i.e. vehicle 314 in the context of FIG. 3) is put under consideration for arrest or detention in connection with a legal offence.

Next in the method 200, a computer-implemented records lookup is carried out (220) to directly or indirectly identify the first and second vehicles (for example, vehicles 314 and 320, noting that while the present example illustration is drawn to two vehicles, in accordance with example embodiments three vehicles, four vehicles, five vehicles, etcetera is also contemplated). In at least one example, the identifying of the first and second vehicles may be facilitated at least in part by employing an Automatic License Plate Recognition (ALPR) system. (As will be appreciated by those skilled in the art, license plate numbers obtained via ALPR can allow matching entries of the vehicle registrations data 190 in the database 164 to be retrieved in order to provide further information concerning the vehicles 314 and 320.)

Next in the method 200, at least one prior-created, first police report (for example, forming part of the police reports data 189) is retrieved (230) in relation to the first vehicle at a second location (for example, the vehicle 314 at second location 324). In at least one example, the first police report details a first stop and release of the first vehicle. Table 1 below provides mock example details for such a police report.

TABLE 1
First Police Report - Mock Example Details

| Report | | |
|---|---|---|
| Detail | Report Detail | |
| No. | Category | Report Detail |
| 1 | Vehicle Stop | Locust, St. Elgin [second location 324] |
| | Location | |
| 2 | Date and Time | Feb. 17, 2023 at 8:00 PM. |
| | of Stop | |
| 3 | Police Officer | John James III [police officer 350] |
| | Name | |
| 4 | Reason for | Tip submitted through tip line by a school |
| | Stop | student. Student saw this car drive up to |
| | | someone near Coleman school, roll down the |
| | | car window and exchange a small bag for |
| | | some cash (i.e. potential drug sale). |
| 5 | Vehicle License | M 2928 |
| | Plate | |
| 6 | Vehicle Make | Ford Focus [vehicle 314] |
| | and Model | |
| 7 | Driver Details | Ronaldo Ryan, Age 22, Resides in Elgin, |
| | | registered student at St. Xavier School. |
| 8 | Descriptive | Officer John James searched through the car |
| | Summary | passenger seat and car boot, and no drugs |
| | of Video | found. Car boot installed with high bass |
| | Captured by | audio speaker. Car and driver released. |
| | Camera(s) | |

Next in the method 200, at least one prior-created, second police report (for example, forming part of the police reports data 189) is retrieved (240) in relation to the second vehicle at a third location different than the second location (for example, the vehicle 320 at third location 328). In at least one example, the second police report details a second stop and release of the second vehicle. Table 2 below provides mock example details for such a police report.

TABLE 2
Second Police Report - Mock Example Details

| Report | | |
|---|---|---|
| Detail | Report Detail | |
| No. | Category | Report Detail |
| 1 | Vehicle Stop | Mohave St., Canyon Pass [third location |
| | Location | 328] |
| 2 | Date and Time | Mar. 1, 2023 at 11:00 PM. |
| | of Stop | |
| 3 | Police Officer | Hugo Henry [police officer 354] |
| | Name | |
| 4 | Reason for | Tip submitted through tip line by a school |
| | Stop | student. Student saw a person entering the |
| | | vehicle outside of St. Xavier school who |
| | | appeared to match the description of a |
| | | wanted drug dealer named Johnny Doe. |
| 5 | Vehicle License | SKB 777 |
| | Plate | |
| 6 | Vehicle Make | BMW 500 Series [vehicle 320] |
| | and Model | |
| 7 | Driver Details | Dan Jackson, Age 37 from Elgin. |
| 8 | Descriptive | Officer Hugo searched through the car |
| | Summary | passenger seat and car boot, no drugs found. |
| | of Video | Upon request, security at St. Xavier school |
| | Captured by | provided CCTV video export file evidencing |
| | Camera(s) | frequent presence of this stopped vehicle |
| | | outside of school. Car boot installed with |
| | | high bass audio speaker. Looked normal. Car |
| | | and driver released because no drugs found |
| | | and identified driver (Dan Jackson) not a |
| | | match to the wanted drug dealer. |

Next in the method 200, report data from each of the first and second police reports is inputted (250) into a learning machine, examples of which have been herein previously described. For instance, at least one processor that implements at least a portion of the neural network module 168 (FIG. 1) may be employed to generate and provide one or more investigative lead suggestions, that are relevant to the potential arrest or detention of one or more people, and that are derived from the details from both of the stop and release-detailing police reports.

Next in the method 200 is decision action 260. For the decision action 260, if the learning machine does not identify (i.e. “NO” branch”) one or more relationship link thresholds for the first and second vehicles having being met, then action 270 follows, and the investigation continues into the one or more vehicle occupants without the first and second vehicles being linked.

On the other hand, if for the decision action 260 the learning machine does identify (i.e. “YES” branch”) one or more relationship link thresholds for the first and second vehicles having being met, then action 290 follows. For instance, the action 290 would follow in the case of the example police reports detailed in the above Tables 1 and 2, because a combination of commonalities (for example, some set of conditions from an association summary or report) found in respect of “Report Details Nos.” 4, 7 and 8 (i.e. school, drug dealing, St. Xavier school, car boot installed with high bass audio speaker in both reports) would result in meeting of the relationship link threshold.

When the action 290 follows, a plurality of police officers identified from both the first and second police reports (for example, police officers 350 and 354) are automatically assigned (280) into a communications group, ad hocly created in respect of the legal offence. In at least one example, the communications group may be a collaborative talk group, officer access to which may be provided by the communications application 146 (FIG. 1). Also, the aforementioned one or more investigative lead suggestions (generated by, for example, the neural network module 168) may be provided within the communications group in the form of at least one of text, audio, images and video. In the case of the example police reports detailed in the above Tables 1 and 2, the investigative lead suggestions might be as follows: “1) Please dismantle and check the high bass audio speaker compartment for potential drug smuggling. 2) Please request that the tip line retrieve and forward details of all tips received during the last 24 hours originating from locations at or near Coleman and St. Xavier schools.”

Other output activity in addition to investigative lead suggestions is also contemplated. For example, dynamically configured audio and/or video analytics may be automatically pushed to camera(s) or other sensors controlled by an officer.

Next after the action 280, a notification is provided (290) to each of the assigned police officers. The notification provides at least one implicit or explicit explanation for the automatic assigning to the communications group. In at least one example, the notification may be provided in the form of a visual notification on the display screen 126 (FIG. 1).

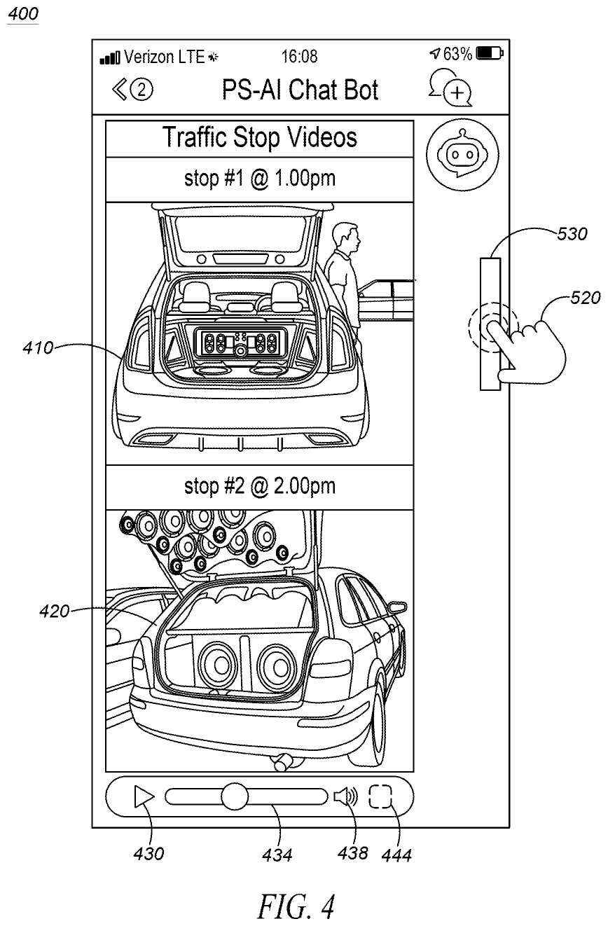

Reference is now made to FIG. 4. FIG. 4 is a diagram of a first example user interface page 400 illustrating video clips 410 and 420 available to be viewed by an assigned police officer. The user interface page 400 may displayed on, for example, the display screen 126 (FIG. 1). In some examples, the user interface page 400 may be integrated into the aforementioned notification of the action 290, or accessed via a protected link within that notification through user interaction in the communications application 146.

Also shown in the user interface page 400 are selectable play button icon 430, a video scrub tool 434, a volume/speaker button icon 438 and a video display enlarger icon 444. The function of these icons and tools will be readily understood to one skilled in the art. In some examples, each of the video clips 410 and 420 is from a different prior traffic stop of one or more of the first and second vehicles. In at least one example, compilation and presentation of the video clips 410 and 420 may be controlled by artificial intelligence action of the neural network module 168. In at least one example, the artificial intelligence action may be based at least in part on captured video provided as input to the neural network module 168 in respect of the first or second vehicle under current investigation.

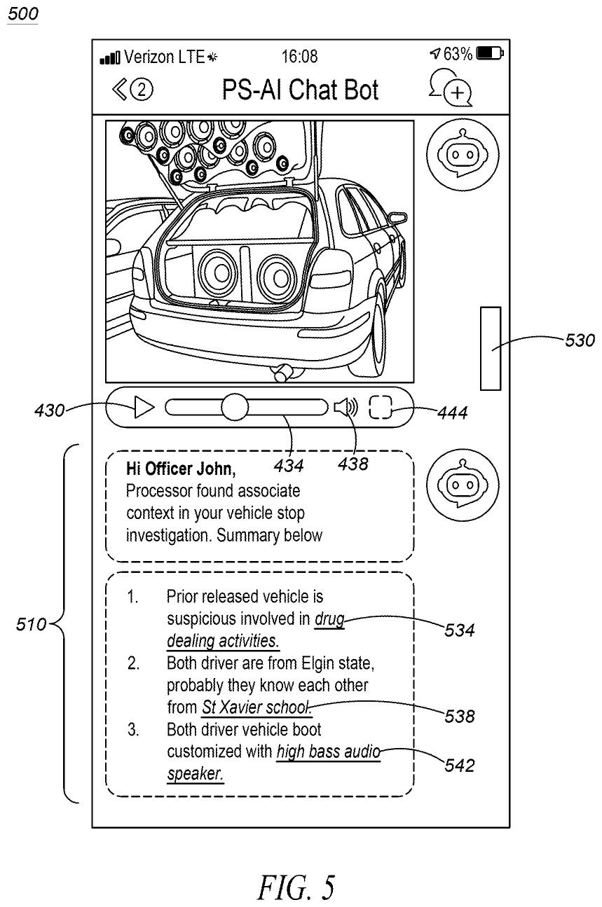

Reference is now made to FIG. 5. FIG. 5 is a diagram of a second example user interface page 500 illustrating chatbot dialogs 510 made visible by downward user finger movement (diagrammatically represented in previous FIG. 4 by pointing hand 520 interacting with slider UI element 530).

The chatbot dialogs 510 integrates a plurality of customized hyperlinks 534, 538, and 542, which serve as dynamic entry points to supplementary investigative data. As the initial evidence gathering phase of a vehicle investigation progresses, the artificial intelligence identifies and prioritizes selective attributes for increasing relevancy. Leveraging these findings, the artificial intelligence action of the neural network module 168 autonomously aggregates associated information, presenting it through the customized hyperlinks 534, 538, and 542 to bolster the comprehensive investigation summary. These hyperlinks are specifically engineered to be adaptive; for instance, they may be tailored to an individual officer's unique profile and operational preferences. By providing highly specific context, the artificial intelligence aims to jog the officer's memory and re-shape their recall of events based on their historical involvement in previous vehicle investigations.

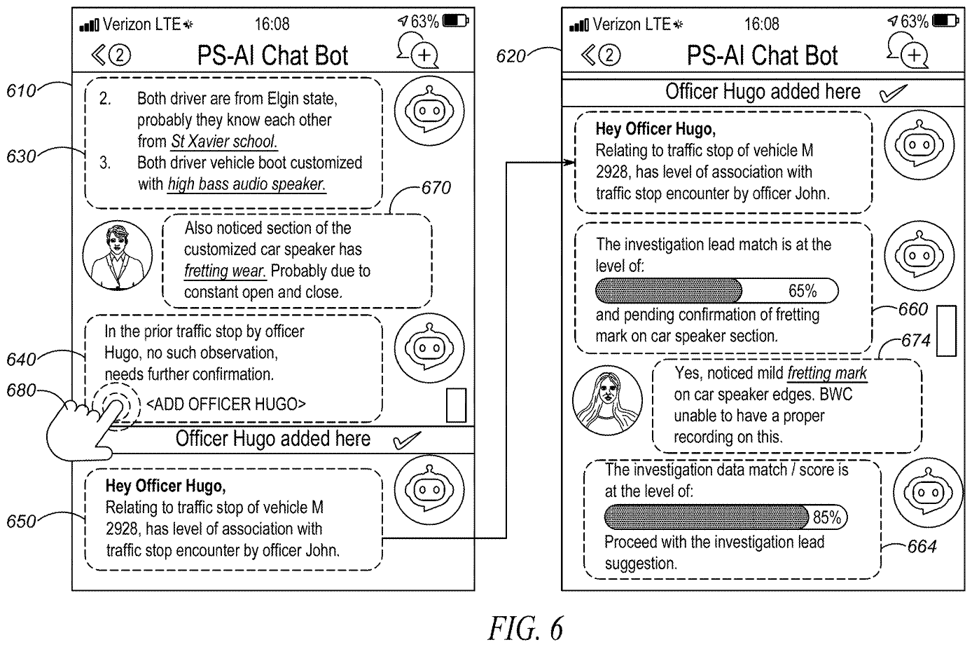

Reference is now made to FIG. 6. FIG. 6 is a diagram of a third example user interface page 610 and a fourth example user interface page 620 illustrating additional chatbot dialogs 630, 640, 650, 660 and 640 interspaced with police officer dialogs 670 and 674.

The third and fourth example user interface pages 610 and 620 further illustrate the artificial intelligence action of the neural network module 168 assisting in an investigation by gathering and assessing information. Per the police officer dialog 670, Officer John provides input that he noticed fretting wear on a customized car speaker, suggesting it was caused by constant opening and closing. Per the chatbot dialog 610: i) both drivers involved are from Elgin state, with the artificial intelligence proposing that they might know each other from St. Xavier school; and ii) both drivers have customized their vehicle boots with high bass audio speakers.

Per the chatbot dialog 640, a prior traffic stop by Officer Hugo did not include this observation, requiring further confirmation. Pointing hand 680 is illustrated adjacent a selectable action “<ADD OFFICER HUGO>” allowing the adding of Officer Hugo to the conversation. Per the chatbot dialog 650, Officer Hugo is alerted about a traffic stop involving vehicle M 2928, noting its association with a traffic stop encounter by Officer John. Per the chatbot dialog 660, the investigation lead match is currently at 65%, pending confirmation of the fretting mark on the car speaker section.

Per the police officer dialog 674, Officer Hugo confirmed noticing a mild fretting mark on the car speaker edges, but stated the Body-Worn Camera (BWC) was unable to get a proper recording of it.

Per the chatbot dialog 664, the overall investigation data match/score is at 85%. Based on this increased score, the artificial intelligence suggests proceeding with the investigation lead.

In some examples, the artificial intelligence has the ability to provide and request additional information to moderate the information pool.

In some examples, when the artificial intelligence has sufficient attributes or evidence for lead matching, it can process the confidence level, and when the confidence is high, the artificial intelligence is able to provide an investigation lead for the next action by officers.

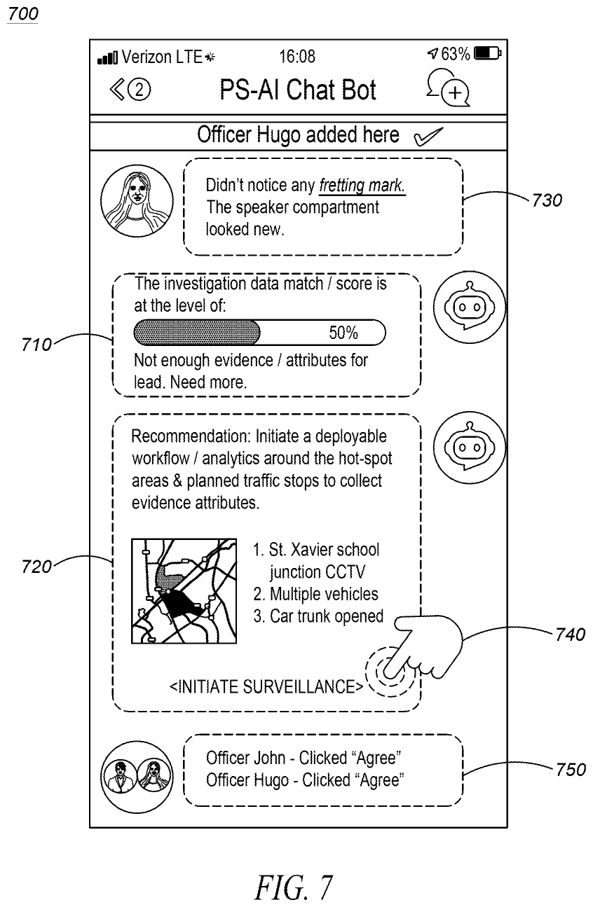

Reference is now made to FIG. 7. FIG. 7 is a diagram of a fifth example user interface page 700 illustrating further additional chatbot dialogs 710 and 720 interspaced with additional police officer dialog 730. The fifth user interface page 700 can be seen as an alternative scenario to the scenario of fourth example user interface page 620, in the sense that it illustrates how an outcome differs when, instead of confirming, Officer Hugo denies noticing a fretting mark.

Per the police officer dialog 730, Officer Hugo contributes observation data, noting that she “Didn't notice any fretting mark.” and reporting that “The speaker compartment looked new”. This feedback is processed by the artificial intelligence, which analyzes Officer Hugo's answer from her respective traffic stop and finds, per the chatbot dialog 710: “Not enough evidence/attributes for lead.” Due to the fact that the initial theory from the artificial intelligence is contradicted by the subsequent feedback provided by the Officer Hugo, the investigation lead matching “confidence score” drops to 50%.

In response to this conflict and the lowered confidence score, the artificial intelligence generates new steps. The recommendation is to “Initiate a deployable workflow/analytics around the hot-spot areas & planned traffic stops to collect evidence attributes”. The overall goal is for the artificial intelligence is to generate recommendations to continuously capture and collect potential alternative leads to bridge the context gap.

Per the chatbot dialog 720, the artificial intelligence recommends that surveillance be initiated. Specific details for the recommended surveillance action include monitoring the “St. Xavier school junction CCTV” and noting observations such as “Multiple vehicles” and a “Car trunk opened”.

“<INITIATE SURVEILLANCE>” within the chatbot dialog 720 is tapped by a user (represented by pointing hand 740). The notification 750 notifies the user that both Officer John and Officer Hugo have provide agreement input in respect of the surveillance recommendation.

As should be apparent from this detailed description above, the operations and functions of the electronic computing device are sufficiently complex as to require their implementation on computer system(s), and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot retrieve police reports data from electronic storage, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A tangible, non-transitory, computer-readable storage medium having instructions encoded therein, wherein the instructions, when executed by at least one processor, cause a carrying out of a method comprising:
providing a user interface for a communications group configured to permit communication of a plurality of electronic messages between a chatbot and a plurality of police officers, the electronic messages including at least one chatbot message;
carrying out a computer-implemented records lookup to directly or indirectly identify first and second vehicles, wherein one or more occupants of the at least one of the first vehicle and the second vehicle are under consideration for potential arrest or detention in connection with a legal offence;
retrieving, from at least one storage, at least one prior-created, first police report in relation to the first vehicle;
retrieving, from the at least one storage, at least one prior-created, second police report in relation to the second vehicle;
inputting report data from each of the first and second police reports into a learning machine; and
receiving output from the learning machine to generate the at least one chatbot message,
wherein the output describes one or more investigative lead suggestions relevant to investigation in respect of the legal offence.

2. A computer-implemented method carried out at least in part at a first location where at least one of a first vehicle and a second vehicle is parked, stationed or stopped, the computer-implemented method comprising:
carrying out a computer-implemented records lookup to directly or indirectly identify the first and second vehicles, wherein one or more occupants of the at least one of the first vehicle and the second vehicle are under consideration for potential arrest or detention in connection with a legal offence;
retrieving, from at least one storage, at least one prior-created, first police report in relation to the first vehicle at a second location;
retrieving, from the at least one storage, at least one prior-created, second police report in relation to the second vehicle at a third location different than the second location;
inputting report data from each of the first and second police reports into a learning machine; and
based on the learning machine identifying one or more relationship link thresholds for the first and second vehicles having being met:
automatically assigning a plurality of police officers identified from both the first and second police reports into a communications group, ad hocly created in respect of the legal offence; and
providing a notification to each of the assigned police officers that provides at least one implicit or explicit explanation for the automatic assigning to the communications group.

3. The computer-implemented method of claim 2 wherein the learning machine is trained to identify commonality or complementary relationship links between respective details of the police reports.

4. The computer-implemented method of claim 3 wherein the commonality or complementary relationship links relate to at least one of an organization, at least one person, a dangerous substance produceable from two or more combinable chemicals, and a dangerous device produceable from two or more integrable components.

5. The computer-implemented method of claim 2 wherein the communications group is a collaborative talk group.

6. The computer-implemented method of claim 2 wherein the first police report details a first stop and release of the first vehicle, and the second police report details a second stop and release of the second vehicle.

7. The computer-implemented method of claim 6 further comprising employing at least one processor to generate and provide one or more investigative lead suggestions, that are relevant to the potential arrest or detention, and that are derived from details from both of the stop and release-detailing police reports.

8. The computer-implemented method of claim 7 wherein the one or more investigative lead suggestions are provided within the communications group in a form of at least one of text, audio, images and video.

9. The computer-implemented method of claim 2 wherein the first and second vehicles are road vehicles.

10. The computer-implemented method of claim 9 wherein the identifying of the first and second vehicles is facilitated at least in part by employing an automatic license plate recognition system.

11. A system comprising:
at least one processor; and
at least one electronic storage medium in communication with the at least one processor, the at least one electronic storage medium storing program instructions that when executed by the at least one processor cause the at least one processor to perform:
carrying out a computer-implemented records lookup to directly or indirectly identify first and second vehicles, wherein one or more occupants of at least one of first vehicle and the second vehicle, parked, stationed or stopped at a first location, are under consideration for potential arrest or detention in connection with a legal offence;
retrieving, from at least one storage, at least one prior-created, first police report in relation to the first vehicle at a second location;
retrieving, from the at least one storage, at least one prior-created, second police report in relation to the second vehicle at a third location different than the second location;
inputting report data from each of the first and second police reports into a learning machine; and
based on the learning machine identifying one or more relationship link thresholds for the first and second vehicles having being met:
automatically assigning a plurality of police officers identified from both the first and second police reports into a communications group, ad hocly created in respect of the legal offence; and
providing a notification to each of the assigned police officers that provides at least one implicit or explicit explanation for the automatic assigning to the communications group.

12. The system of claim 11 wherein the learning machine is trained to identify commonality or complementary relationship links between respective details of the police reports.

13. The system of claim 12 wherein the commonality or complementary relationship links relate to at least one of an organization, at least one person, a dangerous substance produceable from two or more combinable chemicals, and a dangerous device produceable from two or more integrable components.

14. The system of claim 11 wherein the communications group is a collaborative talk group.

15. The system of claim 11 wherein the first police report details a first stop and release of the first vehicle, and the second police report details a second stop and release of the second vehicle.

16. The system of claim 15 wherein execution of the program instructions by the at least one processor further causes generating and providing one or more investigative lead suggestions, that are relevant to the potential arrest or detention, and that are derived from details from both of the stop and release-detailing police reports.

17. The system of claim 16 wherein the one or more investigative lead suggestions are provided within the communications group in a form of at least one of text, audio, images and video.

18. The system of claim 11 wherein the first and second vehicles are road vehicles.

19. The system of claim 18 wherein the identifying of the first and second vehicles is facilitated at least in part by employing an automatic license plate recognition system.

20. The system of claim 11 wherein the first location corresponds to a parking lot or a roadblock.
